(19) United States
(12) Patent Application Publication
(10) Pub. No.: US 2012/0119889 A1
(43) Pub. Date: May 17, 2012

(54) INTERACTIVE MOBILE COMMUNICATION DEVICE

(76) Inventors: MICHAEL A. CARRILLO, Chicago, IL (US); Ragnar Olson, Chicago, IL (US)

(21) Appl. No.: 13/011,210

(22) Filed: Jan. 21, 2011

Related U.S. Application Data
(60) Provisional application No. 61/414,684, filed on Nov. 17, 2010.

(51) Int. Cl. G08C 19/16

(52) U.S. Cl. 340/12.28; 340/12.54

(57) ABSTRACT

A system and method is described for allowing a mobile communication device using location data to control electronic devices located within a predefined area of coverage.

### CROSS-REFERENCE

This application claims the benefit of U.S. Provisional Patent Application No. 61/414,684 filed on Nov. 17, 2010, which is incorporated herein in its entirety.

### BACKGROUND OF THE INVENTION

This invention relates generally to mobile communication devices and more particularly, to using mobile communication devices to control electronic devices, such as televisions, DVD players and other consumer electronic devices.

The use of handheld remotes for controlling a multitude of consumer devices provided by more than one manufacturer has become increasingly common. For example, consumer electronic devices, such as televisions and stereos, are each designed to be controlled with different remote control devices. Further, appliances provided by different manufacturers are typically controlled by remote controls that employ different codes. To minimize the number of individual remote controls, universal remote controls have been developed. The universal remote controls include or may access remote codes for multiple devices and manufacturers and therefore, the universal remote controls may control consumer electronic devices that have different functionality and that are manufactured by different manufacturers.

The production of mobile communication devices that provide communication pathways through voice, data and radio frequency channels (RF) are also becoming increasingly common. Manufacturers produce mobile communication devices such as cell phones and mobile computers, which are designed to communicate with devices wirelessly or via existing landline connections. These pathways may also be used to control electronic devices.

Some mobile communication devices also include advanced location sensors such as Global Positioning Satellite (GPS) receivers and digital compasses that allow a user to determine their exact location. GPS receivers are known to help people find locations of desired points of destination and to provide monitoring capabilities. GPS receivers have not been generally provided in connection with other consumer electronic devices.

### SUMMARY OF THE INVENTION

In accordance with the background described above, the following invention describes systems and methods for allowing mobile communication devices coupled with location-based technology to interact with surrounding electronic devices and to control their operation.

A better understanding of the objects, advantages, features, properties and relationships of the invention will be obtained from the following detailed description and accompanying drawings which set forth an illustrative embodiment and which are indicative of the various ways in which the principles of the invention may be employed.

### BRIEF DESCRIPTION OF DRAWINGS

For a better understanding of the invention, reference may be had to the following Figures, which further describe an embodiment of the present invention and which include drawings and exemplary screen shots therefore;

FIG. 1 is a diagram depicting a mobile communication device;

FIG. 2 is a diagram of a graphical user interface (“GUI”) of the mobile communication device;

FIG. 3 is a flow chart showing the interaction of the mobile communication device with the electronic devices;

FIG. 4 is a diagram of the electronic device and its interaction with the mobile communication device and/or other electronic devices;

FIG. 5 illustrates an exemplary graphical user interface feature depicting an interface that allows users to view electronic devices that are available for control within a particular structure or possibly on a room-by-room or floor-by-floor basis;

FIG. 6 illustrates an exemplary graphical user interface for allowing users to select particular electronic devices to be controlled via the mobile communication device;

FIG. 7A illustrates an exemplary graphical user interface for the Auto Device feature;

FIG. 7B is a flow chart depicting how the mobile communication device interacts with the electronic devices utilizing the LBS and an Auto Device feature;

FIG. 8 illustrates an exemplary graphical user interface with graphical buttons associated with the particular electronic devices that the user may wish to control;

FIG. 9 is a flow chart showing the steps for enabling the control of electronic devices located in proximity to the mobile communication device; and

FIG. 10 is a flow chart showing the process of creating a layout or list of available electronic devices.

### DETAILED DESCRIPTION

Mobile Communication Device

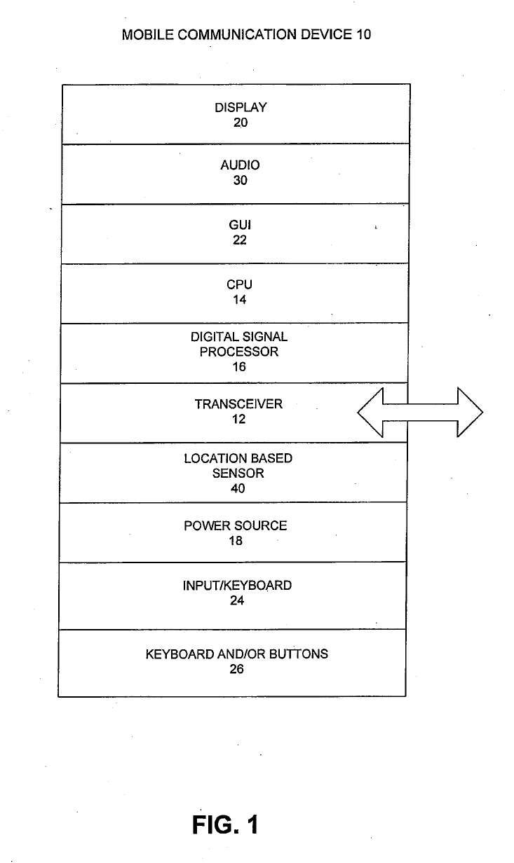

The following describes various systems and methods for allowing a mobile communication device 10 to control electronic devices 50. By way of example, FIG. 1 illustrates an exemplary mobile communication device 10 that includes a transmitter and a receiver (or transceiver), generally labeled as 12, a central processing unit (CPU) 14, a digital signal processor (DSP) 16, a power source 18, a display 20 and a graphical user interface (GUI), generally labeled as 22. The mobile communication device 10 may also include an input key or keys 24, including a keyboard and/or buttons 26 (not shown), such as a power button or volume controls, a location based sensor (LBS) 40 and an audio module 30. It should be obvious to those with skill in the art that the mobile communication device 10 may be a laptop computer, a portable music/video player, a cellular telephone, a smart phone or any similar electronic device capable of wirelessly communicating with other mobile communication devices or electronic devices and may also include other hardware, software or functionality. As will be described in more detail below, the user interface may also include a hierarchical display of the relative electronic devices. For example, the user may be able to select whether they would like to see available electronic devices in a particular room, floor, house, building, city, state, country, or geographic area or location.

Graphical User Interface

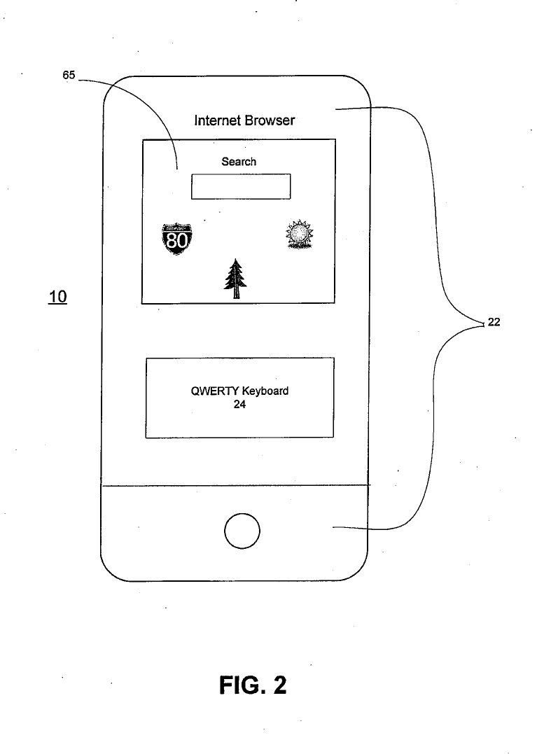

As shown in FIG. 2, a GUI interface 22 may be provided to allow a user to interact with the mobile communication device 10 and to control the mobile communication device 10 by selecting objects, scrolling through content, expanding objects, shrinking objects, typing text, running software and controlling audio and video functions. The GUI interface 22 may also be used to navigate the Internet 65, to implement software and audio/visual works and to control electronic devices 50, as will be described in more detail below. The functionality provided by the GUI interface 22 is well-known in the art and may allow a user of the mobile communication device 10 to manipulate screen selections, pull-down menus, button selection and the general navigation and control of software that is being operated by the mobile communication device 10, including the Internet and software for controlling other external electronic devices in accordance with the teaching of the present invention. As described below, the GUI interface 22 may allow users to employ a multitude of functions and capabilities to facilitate the operation of surrounding electronic devices 50. The functions and capabilities described herein are merely examples of the functions and capabilities that may be provided by the GUI interface 22 and should not be viewed as limiting the scope of the present invention.

Audio Module

For allowing the mobile communication device 10 to provide audio presentation of data and musical content to a user, the mobile communication device 10 may include an audio module 30. The audio module 30 may be positioned internal to the mobile communication device 10 and/or external to the mobile communication device 10. If the audio portion 30 is positioned external to the mobile communication device 10, the audio module 30 may be in either wired or wireless communication with the mobile communication device 10.

Display

To allow users to utilize visual content, including employing the GUI interface 22, navigating Internet websites 65 and controlling other electronic devices 50, the mobile communication device 10 may include a display 20. The display 20 may further include commonly know elements such as an image processor and may form an integral part of the mobile communication device 10. In addition, it should be obvious that the display 20 may exist separately from the mobile communication device 10 and may be in wired or wireless communication with the mobile communication device 10. Thus, the display 20 may be a separate external display, a virtual display or any other similar visual means for allowing users to utilize visual content via the mobile communication device 10.

Central Processing Unit

The CPU 14 of the mobile communication device 10 may process the various functions of the mobile communication device 10 including the functions and capabilities provided by the transceiver 12, the digital signal processor 16, the power source 18, the display 20, the GUI interface 22, and the input keys 24 and buttons 26 (not shown). These functions may be processed one at a time or concurrently depending on the specific processor implemented in the mobile communication device 10. As is widely known in the industry, these functions may be stored on the mobile communication device 10 as instructions in various types of memory circuitry, such as non-volatile electronically-erasable, programmable read-only memory (EEPROM), flash read-only memory (ROM), hard-drive, etc. so that the information is not lost when the mobile communication device 10 is powered down. The relevant software for carrying out conventional operations on the mobile communication device 10 may also be uploaded to the mobile communication device 10 via one or more networks such as the Internet 65, local area networks (LAN), wide area networks (WAN), virtual private networks (VPN), or similar communication networks that may exist or that may be developed in the future. It should also be obvious to those with skill in the art that the above-referenced functions and data may be processed by various processing means, including parallel processors, cloud computing, or other similar technology that may currently exist or developed in the future.

The mobile communication device 10 may also include hardware and software components coupled to the CPU 14 for performing network data exchanges. The mobile computing arrangement may include multiple networks interfaces for maintaining any combination of wired or wireless data connections. In particular, the illustrated mobile communication device 10 may include wireless data transmission circuitry and software for performing network data exchanges. The network interface may include a combination of hardware and software components, including media access circuitry, drivers, programs, and protocol modules.

As mentioned above, the CPU 14 may receive and process executable instructions for carrying out tasks and functions. These executable instructions may include electronic device interfaces and software that provide information for enabling the mobile communication device 10 to communicate with other electronic devices 50. After communication is established between the mobile communication device 10 and other electronic devices 50, the mobile communication device 10 may store data related to those electronic devices 50. For example, one or more location-aware software applications may receive data that is representative of the location of the electronic devices 50 that are in communication with the mobile communication device 10.

Digital Signal Processor

The mobile communication device 10 may further include a digital signal processor (DSP) 16 for performing analog-to-digital (A/D) conversion, digital-to-analog (D/A) conversion, speech coding/decoding, encryption/decryption, error detection and correction, bit stream translation, filtering etc. Digital signal processors are commonly know in the industry and the details associated with DSPs are not critical to the present invention. It should be obvious, therefore, that the DSP 16 may be integrated into the CPU 14 or omitted if future technology requires use of other signal processing circuitry or the need for signal processing technology ceases.

Transceiver

For transmitting and receiving various wireless signals, the mobile communication device 10 may include a transceiver 12. The transceiver 12 may receive wireless signals of various formats, including 802.11, WiFi, IRDA, RF, CDMA, TDMA, GSN, 3G, 3GMA, UTMS, WIMAX, LTE, etc. The formats described above are well known in the art. Use of standardized formats is advantageous for use in conjunction with existing consumer electronic devices and the present invention.

The mobile communication device 10 may also include an alternate/data/voice interface (not shown) coupled to the CPU 14. The alternate network/data interface may include the ability to communicate on secondary networks such as but not limited to peer-to-peer and ad hoc networks using any manner of data transmission medium, including wired and wireless mediums. Examples of alternate network/data interfaces include but are not limited to USB, Bluetooth, Ethernet etc.

Location Based Sensor

To determine the relative position of the mobile communication device 10 with respect to other electronic devices or points of interest, a location based sensor 40 may be provided. The location based sensor 40 may be provided by including location based sensor circuitry and location based software. The combination of the location based circuitry and software will enable the mobile communication device 10 to perform location specific actions. To transmit and receive location data 42 (not shown), the mobile communication device 10 may access one or more networks 44 (not shown) via wired or wireless network interfaces that are in communication with the mobile communication device 10. The networks 44 may include any combination of private and public networks, and may range in size from small and ad hoc, peer-to-peer networks to global area networks, such as the Internet. Generally, the networks 44 provide network data services to the mobile communication device 10 on a client-server basis and the mobile communication device 10 has access to various databases and communication mediums via the networks 44.

The mobile communication device 10 may interact with the electronic devices 50 to determine their relative location. The electronic devices 50 may or may not have location based sensor circuitry. The electronic devices 50 may also communicate directly with the mobile communication device 10 so that the mobile communication device 10 will be able to determine the location of each of the electronic devices 50 relative to the mobile communication device 10. Another embodiment will allow the mobile communication device 10 to determine the location of the electronic devices 50 relative to the mobile communication device 10 and to determine the relative surroundings of the electronic device 50 and mobile communication device 10 such as when an electronic device 50 is located in a particular room, floor, building, town, city, state, and country, and planet.

The mobile communication device 10 may provide some or all of the location-aware client functionality. This functionality will allow users to download, upload, search for, index, and otherwise process network content that includes location data 42 for objects via the mobile communication device 10. This location data 42 may be exchanged with other electronic devices. The LBS 40 is adapted to detect the location of the mobile communication device and/or orientation of the mobile communication device 10 and to convert the location data 42 into usable data for use in controlling other electronic devices or performing other functions that may be provided by the mobile communication device 10.

Location data 42 may also be generated by the mobile communication device 10 or other electronic devices 50 by using Radio Frequency Identity (RFID) technology, as is well known in the art. RFID systems are generally described in U.S. Pat. Nos. 3,713,148 and 5,438,335, which are hereby incorporated by reference. Use of standardized and inexpensive RFID technology may be advantageous for use in conjunction with existing consumer electronic devices and the present invention.

The mobile communication device 10 described herein may also be used to receive, store and process tracking and monitoring information related to one or more electronic devices 50 that are in wired or wireless communication with the mobile communication device 10. This may be further dictated by the proximity of the electronic device 50 to the mobile communication device 10. Moreover, the mobile communication device 10 may also work in combination with the location based sensor 40 to sense the location of the mobile communication device 10 and display enabled electronic devices 50 that are within a predefined range for tracking, controlling, and monitoring electronic devices 50 or assets. For example, in accordance with the present invention, the mobile communication device 10 may utilize the location based sensor 40 to monitor and track assets, such as medical equipment or inventory. Complementary modes of communication may also be used simultaneously or in sequence when multiple modes are available. The availability of one communication medium may preempt transmission of data via another communication medium, thereby increasing the throughput of data and efficiency of communication between the mobile communication device 10 and available electronic devices 50. In another embodiment, multiple communication mediums may be used simultaneously to increases the flow and the reliability of the data may be enhanced through redundant transmission.

The present invention may facilitate business or social networking among users of the mobile communication device 10. In particular, the method enables users of the mobile electronic device 10 to meet or interact with one another user, preferably on a permission basis. For example, the mobile communication device 10 may display available users of other mobile communication devices 10a that are located within physical proximity of the user's mobile communication device 10. The ability to determine when other mobile communication devices 10a are located within a predefined proximity to the mobile communication device 10 may be provided by the location based sensor 40.

Power Source

The power source 18 for this mobile communication device 10 may come from a battery such as lithium, nickel, or other inorganic or organic power sources. Other power sources may also be used in connection with the mobile communication device 10 without departing from the tenets of the present invention. For example, power may also be supplied to the mobile communication device 10 through fuel cells, solar, wind, nuclear, kinetic motion, the Ethernet or wireless transmissions. The power source 18 may also include combinations or hybrid models of the power sources or supply forms disclosed above.

Input Keys and Buttons

For inputting data into the CPU 14, the mobile communication device 10 may include input keys 24 and buttons 26 (not shown). As shown in FIG. 2, the input keys 24 may be graphical buttons depicted on the display 20 and may form graphical keyboards, such as QWERTY keyboards or other similar such keyboards. The input keys 24 may also be physical keys that are formed on the mobile communication device 10, which are generally know in the art. The input keys 24 may also include other general input devices such as cameras, microphones, pointing devices, trackballs, joysticks, graphical user interfaces and other electronic circuitry capable of sensing or receiving external data and uploading it to the CPU 14 of the mobile communication device 10. The mobile communication device 10 may also include buttons 26 for actuating certain functions, such as power, sound, hard returns, etc. Using physical buttons for actuating functions is well known in the industry.

Additionally, the input keys 24 may be formed as virtual input devices. Virtual input devices may include, but are not limited to, virtual keypads, virtual file display systems, virtual saved images, voice activated virtual commands, virtual images of current locations, virtual images of remote locations, virtual images of a user and virtual images of other parties.

Control of External Electronic Devices

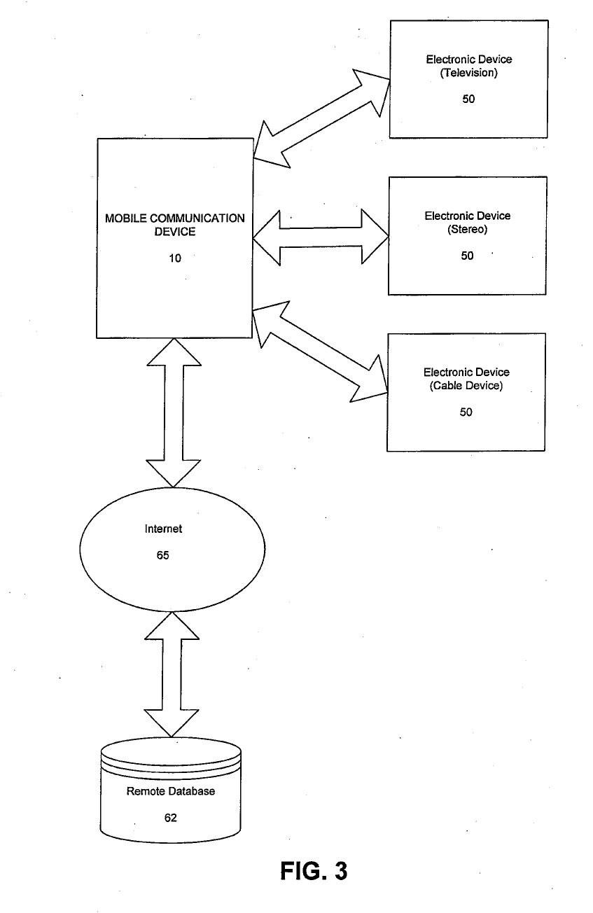

In one embodiment of the present invention, the mobile communication device 10 may be enabled to control external electronic devices 50, including, but not limited to, televisions, stereos, DVD players, cable devices, etc. As shown in FIG. 3, the mobile communication device 10 may also be capable of controlling multiple electronic devices that are supplied by more than one manufacturer. To this extent, the mobile communication device 10 may act as a universal remote control, as that term is used in the industry.

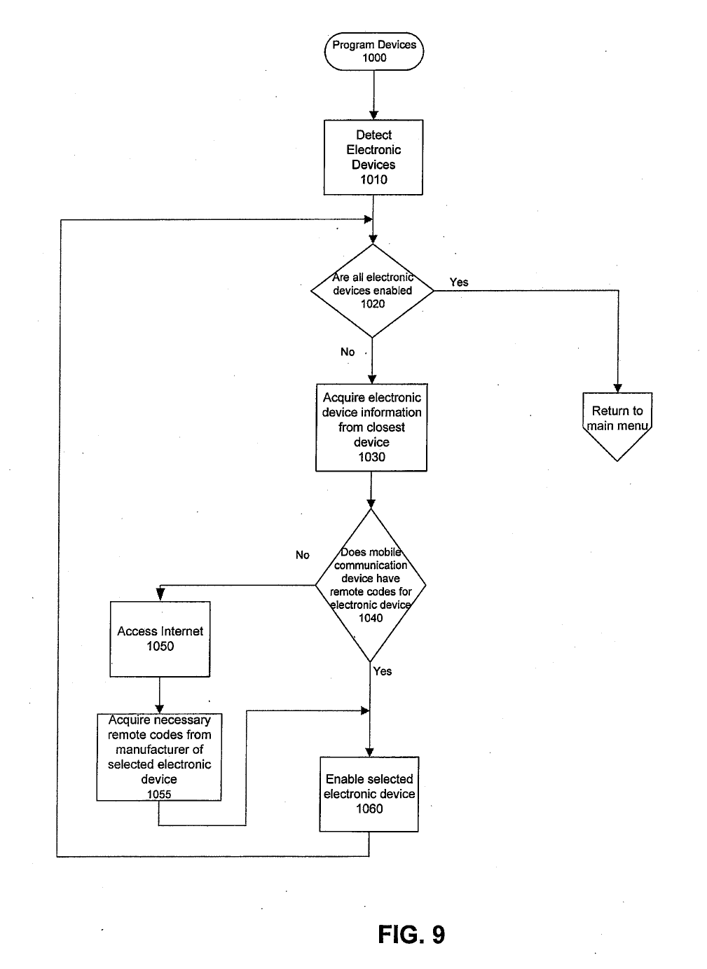

In this embodiment of the present invention, the mobile communication device 10 may need to enable available electronic devices 50 (see step 1000 in FIG. 9). Next, the mobile communication device 10 may assess whether there are available electronic devices 50 to be controlled at step 1010. If there are available electronic devices 50, the mobile communication device 10 may then determine whether it is configured to operate each of the available electronic devices 50 (step 1020). If any of the electronic devices 50 are not enabled, the mobile communication device 10 may initiate the set-up process with the electronic device 50 that is in closest proximity to the mobile communication device 10 (step 1030). The first step in the set-up process is to determine whether the mobile communication device 10 possesses the necessary access codes (not shown) for controlling the specific electronic device 50a (step 1040). If the mobile communication device 10 does not possess the necessary access codes, it may access the Internet 65 (step 1050) and obtain the access codes associated with the specific electronic device 50a through a remote database 62 (step 1055). After the mobile communication device 10 obtains the access codes, the specific electronic device 50a will be enabled and available for control (step 1060). The mobile communication device 10 will then iterate to the next available electronic device 50 that is not configured by going back to step 1020 and will continue until all available electronic devices 50 are configured.

Graphical User Interface Configuration

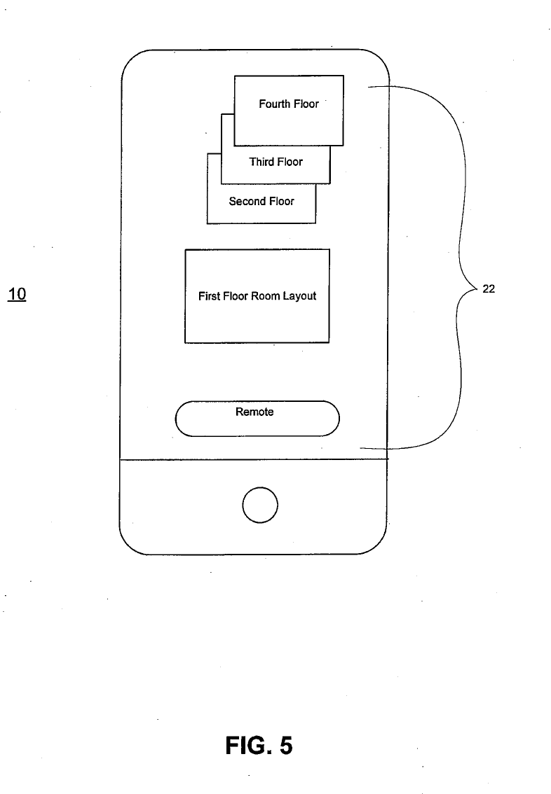

To assist users of the mobile communication device 10 with controlling electronic devices 50 that are located in various rooms of a structure, the mobile communication device 10 may display a graphical user interface 22 that is representative of the structure and the rooms that form the structure. By way of example, the structure may be a home, an office building, an apartment building, a corporate headquarters, a business or other similar dwellings. FIG. 5 illustrates an exemplary graphical user interface 22 feature depicting an interface that allows users to view electronic devices 50 that are available for control within a particular structure or possibly on a room-by-room or floor-by-floor basis. For example, a user may decide to control electronic devices 50 that are located in the living room, kitchen or master bedroom for the structure.

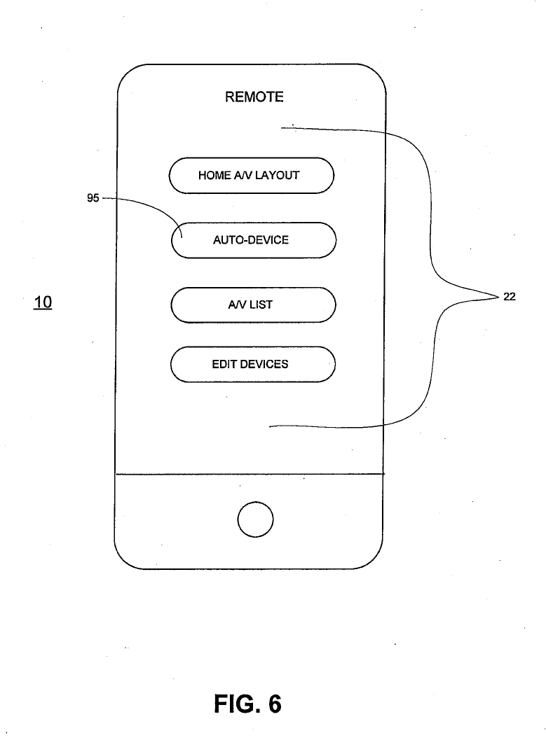

FIG. 6 illustrates an exemplary graphical user interface 22 for allowing users to select the manner in which available electronic devices 50 may be displayed to a user via the mobile communication device 10. The methods for displaying available electronic devices 50 are merely examples and other methods for conveying this information to users may be employed without departing from the scope of this invention. As shown in FIG. 6, the mobile communication device may display one or more graphical buttons associated with the different methods of displaying available electronic devices 50 to a user. For example, FIG. 6 shows buttons for displaying available electronic devices 50 in a Home A/V Layout mode, an Auto-Device mode, or an A/V List mode.

If the Home A/V Layout button is selected, the display 20 may respond by showing a two-dimensional or three-dimensional depiction of a home or building floor plan with graphical representations of the available electronic devices 50 located in various rooms therein. Other floor plans or graphical depictions may also be used.

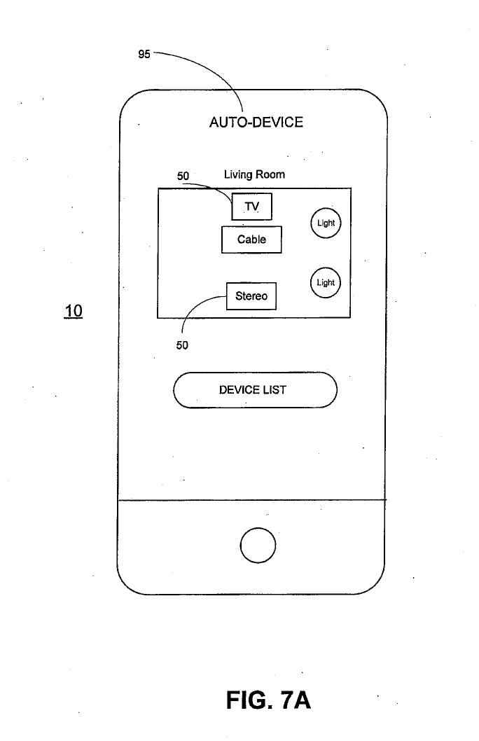

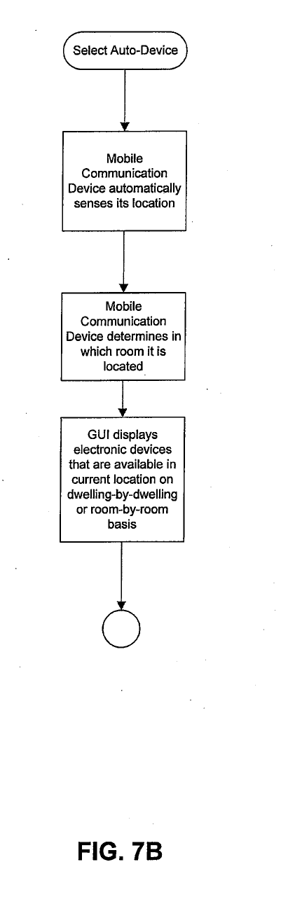

FIG. 7A illustrates an exemplary graphical user interface showing the Auto Device 95 feature. As shown in FIG. 7A, when the Auto Device 95 feature is selected, the display may then show all electronic devices 50 located within a predefined area. The predefined area may be the room in which the user is located, the structure in which the user is located, or a physical zone associated with the user. Other rules for determining which electronic devices 50 are displayed for control by a user may also be employed and should be viewed as being within the scope of the present invention.

If the A/V List button is selected, the display 20 may show a list of available electronic device 50 instead of graphical depictions of the electronic devices 50. The list may be organized on a room-by-room, floor-by-floor, or structure-by-structure basis or in accordance with any other predefined rules for grouping available electronic devices 50 in a hierarchal manner without departing from the tenets and teachings of the present invention.

To edit the presentation, organization or inclusion of electronic devices in the Home A/V Layout, Auto-Device or A/V List interfaces, users may select the Edit Devices buttons. Section of the Edit Devices button may allow users to access various user interfaces that allow users to add, remove, re-organize or highlight selected electronic devices 50 for display to the user on the GUI 22 of the mobile communication device 10.

FIG. 7B is a flow chart depicting how the mobile communication device 10 interacts with the electronic devices 50 utilizing the LBS 40 and an Auto Device 95 feature, and which displays the available electronic devices 50 for a particular room. The Auto Device 95 feature may allow the mobile communication device 10 to automatically sense available electronic devices 50 and to determine the location of the electronic device 50 on a room-by-room, floor-by-floor or structure-by-structure basis. To determine the availability or location of the electronic devices 50, the Auto Device 95 feature may use location based sensors 40 and location data 42, as described above. The GUI 22 on the mobile communication device 10 may display the electronic devices 50 on a room-by-room, floor-by-floor or structure-by-structure basis.

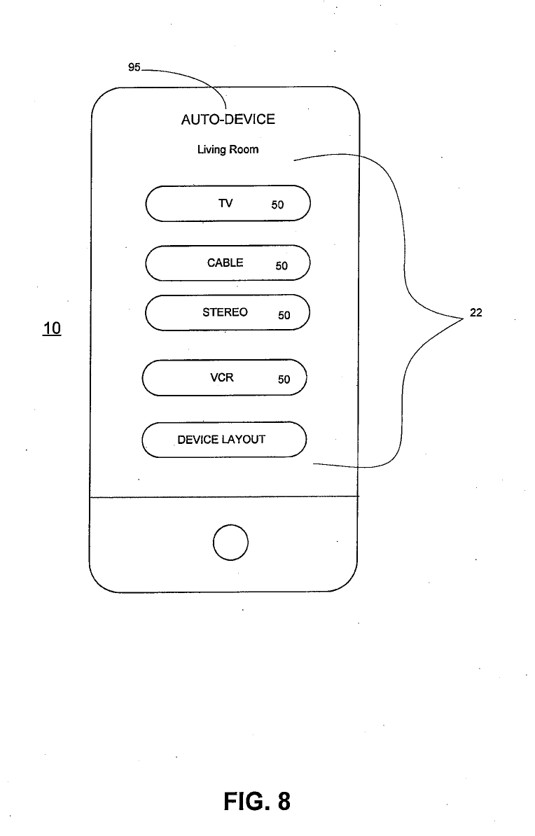

To allow users to control particular electronic devices 50, the mobile communication device 10 may include a graphical user interface 22 that depicts symbols for the various electronic devices 50 that are available for the user to control. FIG. 8 illustrates an exemplary graphical user interface 22 with graphical buttons associated with the particular electronic devices 50 that the user may wish to control, such as televisions, cable boxes, stereos, DVD players and similar consumer electronic devices.

The graphical user interface 22 described above may also provide a hierarchical display of the relative electronic devices. For example, the user will be able to select whether they would like to see the electronic devices 50 in a particular room, floor, house, building, city, state, country, and planet.

The specific electronic devices 50 may be represented by icons, visual buttons, and/or text and may be customizable according to the users discretion. The icons and text may include various additional features that increase their usefulness. For example, the characteristics of an icon and the text can change depending on the distance of the representative object from the user. For example the icon could be displayed smaller if the representative object is farther away. Any combination of size, color, line style, design, transparency, may be used to indicate distance from the user. The icon and/or text may also have enhanced features of Web page objects. For example the icons and text may be user selectable, and contain hyperlinks and descriptive text.

Electronic Device Configuration

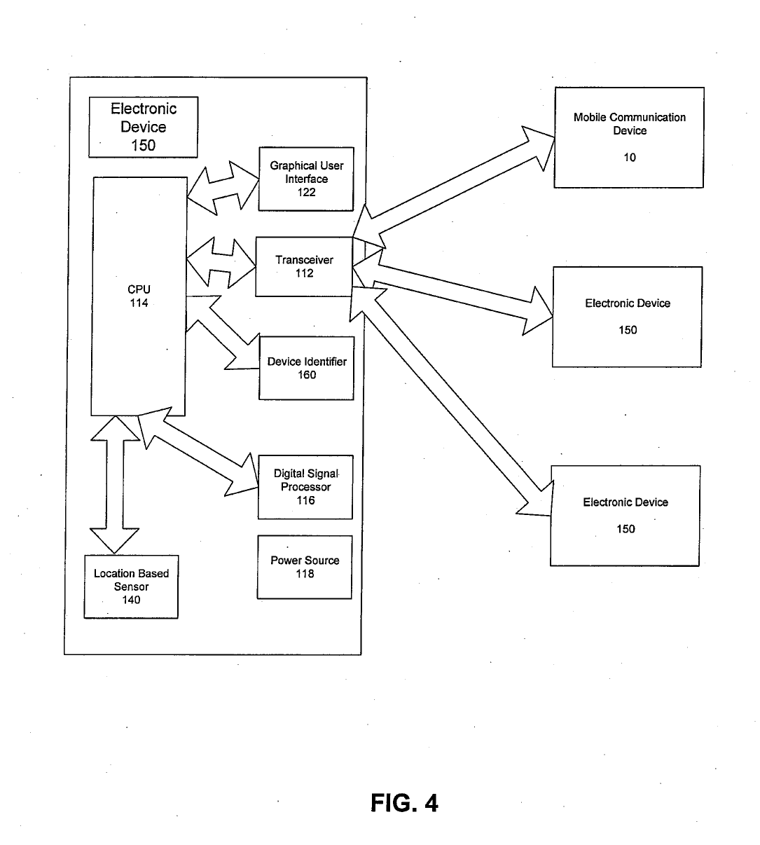

In another embodiment of the present invention, the mobile communication device 110 may interact with an electronic device 150 that includes a location based sensor 140 (LBS). FIG. 4 illustrates an exemplary electronic device 150 that includes a central processing unit (CPU) 114, a graphical user interface (GUI) 122, a transceiver 112, an LBS 140, a device identifier 160, a digital signal processor (DSP) 116 and a power source 118. It should be understood by those with skill in the art that the electronic device 150 may be any consumer electronic device, including, but not limited to, televisions, stereo equipment, display devices, appliances, satellite systems, automobiles, laptop computers, music/video players, digital media devices, gaming systems, theatres, billboards, digital advertisements, or similar such devices.

In this embodiment of the present invention, the electronic device 150 may exchange information with the mobile communication device 110 by using its transceiver 112. In addition to utilizing the location data 142 (not shown) for the mobile communication device 110, however, the electronic device may also provide location data 142a (not shown) to the mobile communication device 110 which allows the mobile communication device 110 to determine the relative location of the electronic device 150 with respect to the mobile communication device 110. Including an LBS 140 as part of the electronic device 150 may also assist with creating a graphical user interface that is representative of multiple electronic devices 150 that are located in different rooms or different parts of a room or structure.

It should also be obvious to those with skill in the art that the CPU 114, the transceiver 112, the DSP 116, the power source 118, and the LBS 140 described in connection with the second embodiment of the present invention are similar in scope and functionality to the similarly referenced elements described in connection with the mobile communication device 10 associated with the first embodiment.

Device Identifier

To assist with configuration of electronic devices 150 by a mobile communication device 110, the electronic device 150 may include a device identifier 160. The device identifier may provide various device information 162 (not shown), including, but not limited to, the manufacturer, the functionality, the control codes and the operating constraints of the electronic device 150. This will allow the mobile communication device 110 to determine whether the mobile communication device 110 is compatible with the electronic device 150 and whether the mobile communication device needs to obtain access codes in order to control the electronic device 150.

The device identifier 160 may also be used to allow for a streamlined configuration when the mobile communication device 110 is re-configuring itself to control an electronic device 150 that it previously controlled. Depending on the security settings, the mobile communication device 110 may be able to quickly control an electronic device 150 that was formerly configured. The mobile communication device 110 may also employ security features so that the parental settings may be set up to limit certain electronic devices from being accessed by certain people. The device identifier 160 may also be used to determine the location of the electronic device 150 and the device identifier 160 and the LBS 140 may be combined to form a single circuit.

Electronic Device Recognition

The mobile communication device 110 may be connected to the electronic devices 150 either manually or automatically. If the connection is automatic, as shown in FIG. 9, the mobile communication device 110 may detect the electronic devices 150 and open up one or more communication pathways connecting the mobile communication device 110 to available electronic devices 150 to determine whether each specific electronic device 150 is configured for control. If a particular electronic device 150a is configured, then the mobile communication device 110 will be able to control particular features of the electronic device 150a and the list of electronic devices 150 available for control by a particular mobile communication device 110 will be updated and displayed.

If the electronic device 150 is not enabled, then the mobile communication device 110 may obtain the device identifier 160 and determine whether it possesses the necessary access codes for operating the electronic device 150. If the mobile communication device 110 does not possess the necessary access codes, the mobile communication device 110 may access the Internet 65 to acquire the access codes from a remote database or upload the access codes from the device identifier 160 or the respective electronic device. Once the necessary access codes are obtained, the electronic device 150 may be configured. If the access codes are already contained by the mobile communication device 110, then the mobile communication device 110 may configure the electronic device 150 without taking steps to acquire the access codes for the electronic device 150. It should be obvious that the functionality described with respect to the second embodiment of the present invention may exist on a stand-alone basis or as part of the functionality described in connection with the first embodiment of the present invention.

Graphical User Interface Layout Creation

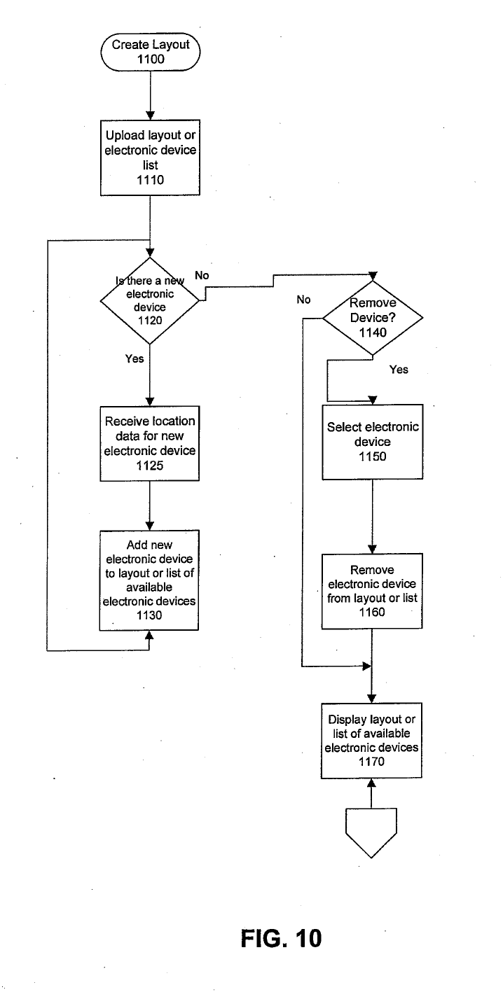

To operate electronic devices 50, 150 associated with various embodiments of the present invention, the mobile communication device 10, 110 may utilize a layout for the desired location with visual representations of the available electronic devices 50, 150 or a list of available electronic devices 50, 150. FIG. 10 is a flowchart illustrating one algorithm for generating such a layout or list for a particular location (step 1100). The layout or list of electronic devices 50, 150 for a particular location may be uploaded or downloaded from the Internet or other data sources, including one of the electronic devices 50, 150 or a separate computer system associated with one or more of the available electronic devices 50, 150 (step 1110). The mobile communication device 10, 110 may also determine if a new electronic device 150b is in its presence (step 1120). If a new electronic device 50b, 150b is present, the mobile communication device 10, 110 may obtain the LBS 40, 140 information from the new electronic device 150b (step 1125) and add the new location data 42, 142 (not shown) to the electronic device list displayed on the mobile communication device 10, 110 (step 1130). If no new devices exist, then the user may be presented with a GUI 22, 122 presenting the user with an option for removing electronic devices 50, 150 from the GUI 22, 122 (step 1140). If the user would like to remove an electronic device 50c, 150c, then the user may select the electronic device 50c, 150c for removal (step 1150) and the selected electronic device 50c, 150c will be removed from the layout list (step 1160). Once all of the electronic devices 50, 150 have been added or removed, the mobile communication device 10, 110 may display the layout or list of electronic devices 50, 150 (step 1170).

While specific embodiments of the present invention have been described in detail, it will be appreciated by those skilled in the art that various modifications and alternatives to those details could be developed in light of the overall teachings of the disclosure. For example, the processes described with respect to computer executable instructions can be performed in hardware or software without departing from the spirit of the invention. Furthermore, the order of all steps disclosed in the figures and discussed above has been provided for exemplary purposes only. Therefore, it should be understood by those skilled in the art that these steps may be rearranged and altered without departing from the spirit of the present invention. In addition, it is to be understood that all patents discussed in this document are to be incorporated herein by reference in their entirety. Accordingly, the particular arrangement disclosed is meant to be illustrative only and not limiting as to the scope of the invention which is to be given the full breadth of the appended claims and any equivalents thereof.

What is claimed is:

1. A method for controlling one or more electronic devices with a mobile communication device, the method comprising:
receiving information associated with the one or more electronic devices;
configuring the mobile communication device to control one or more of the electronic devices;
receiving location data associated with the mobile communication device; and
displaying electronic devices within a predefined area, where the predefined area is based on the location data associated with the mobile communication device.

2. The method for controlling electronic devices described in claim 1, further including the step of receiving location data for each of the electronic devices.

3. The method for controlling electronic devices described in claim 1, wherein the mobile communication device includes a location based sensor.

4. The method for controlling electronic devices described in claim 1, wherein one or more of the electronic devices includes a device identifier that provides location data for each of the respective electronic devices.

5. The method for controlling electronic devices described in claim 4, wherein the device identifier provides access codes for the electronic device associated with each of the device identifiers.

6. The method for controlling electronic devices described in claim 1, wherein the predefined area is designated as one or more rooms in an building.

7. The method for controlling electronic devices described in claim 1, wherein the predefined area is designated as one or more buildings.

8. The method for controlling electronic devices described in claim 1, wherein the predefined area is designated as one or more geographic areas.

9. The method for controlling electronic devices described in claim 1, wherein the predefined area is designated as one or more floors in a building.

10. The method for controlling electronic devices described in claim 1, wherein the predefined area is designated as one or more rooms, on one or more floors, in one or more buildings, located in one or more geographic areas.

11. A mobile communication device for controlling one or more electronic device comprising,
a transceiver for sending and receiving data;
a central processing unit (CPU);
a digital signal processor (DSP);
a location based sensor for generating location data associated with the mobile communication device;
a graphical user interface (GUI) for displaying the electronic devices available for control by the mobile communication device and located within a predefined area.

12. The mobile communication device described in claim 11, wherein the mobile communication device receives location data for each of the electronic devices.

13. The mobile communication devices described in claim 12, wherein the location data for each of the electronic devices is used to determine which of the electronic devices are available for control by the mobile communication device.

14. The mobile communication devices described in claim 11, wherein the mobile communication device includes a location based sensor.

15. The mobile communication devices described in claim 11, wherein one or more of the electronic devices includes a device identifier that provides location data for each of the respective electronic devices.

16. The mobile communication devices described in claim 15, wherein the device identifier provides access codes for controlling the electronic device associated with each of the device identifiers.

17. The mobile communication devices described in claim 11, wherein the predefined area is designated as one or more rooms in a building.

18. The mobile communication devices described in claim 11, wherein the predefined area is designated as one or more floors in a building.

19. The mobile communication devices described in claim 11, wherein the predefined area is designated as one or more rooms, on one or more floors, in one or more buildings.

20. An electronic device configurable for operation by a mobile communication device, comprising:
a transceiver for sending and receiving data;
a central processing unit (CPU);
a digital signal processor (DSP);
a location based sensor for generating location data associated with the electronic device;
wherein the transceiver for the electronic device sends the location data to the mobile communication device; and
wherein the mobile communication device uses the location data to determine whether to display the electronic device for operation.
